(19) United States
(12) Patent Application Publication
(10) Pub. No.: US 2011/0059656 A1
(43) Pub. Date: Mar. 10, 2011

(54) ELECTRICAL CONNECTOR AND TERMINAL STRUCTURE THEREOF

(76) Inventor: Chou Hsien TSAI, Sinjhuang City (TW)

(21) Appl. No.: 12/875,896

(22) Filed: Sep. 3, 2010

(30) Foreign Application Priority Data
Sep. 4, 2009 (TW) 098216442
Jan. 22, 2010 (TW) 099111516

(51) Int. Cl. H01R 24/00

(52) U.S. Cl. 439/660

(57) ABSTRACT

An electrical connector includes a plastic base and one row of terminals disposed in one row of terminal slots of the base. Each terminal has an extension fixed to the slot, a fixing portion and a pin portion. The extension in surface contact with the slot has a connection point. The pin portion extends out of the base. The row of terminals is one of two rows of terminals formed by oppositely tearing and pressing a metal sheet. Two of the terminals of the two rows of terminals respectively have two oppositely torn and cut portions seamlessly and oppositely connected together. The oppositely torn and cut portion of the one terminal is seamlessly connected to the oppositely torn and cut portions of the two neighboring terminals when the one terminal is reversely and oppositely connected to the two neighboring terminals. The oppositely torn and cut portions are the extensions.

### BACKGROUND OF THE INVENTION

1. Field of the Invention

The invention relates to an electrical connector, and more particularly to an electrical connector having terminals formed by way of pressing in a material-saving manner.

2. Related Art

Terminals of an electrical connector are usually manufactured by pressing a metal sheet, and the pressed terminals are separately arranged and connected to a material tape according to a terminal gap of the electrical connector. Thus, the whole row of terminals may be assembled in a plastic base of the electrical connector at a time.

The whole row of continuously arranged terminals is formed by pressing a metal sheet, wherein the spaced region between two neighboring terminals is formed by removing a portion of the metal sheet. So, this portion becomes a waste product. Thus, the waste product has to be reduced if the cost of pressing the terminals has to be decreased.

### SUMMARY OF THE INVENTION

It is therefore an object of the invention to provide an electrical connector having terminals formed by way of pressing, wherein extensions of two rows of terminals may be seamlessly oppositely connected together and then pressed, so that the material and the manufacturing cost may be reduced.

The invention achieves the above-identified object by providing an electrical connector including a plastic base and at least one row of terminals. The plastic base has at least one row of terminal slots. The at least one row of terminals is disposed in the at least one row of terminal slots of the plastic base. Each of the terminals has, from one end to the other end, an extension, a fixing portion and a pin portion. The fixing portion is fixed to the terminal slot. The extension is in surface contact with the terminal slot and has a connection point. The pin portion extends out of the plastic base. The at least one row of terminals is one of two rows of terminals formed by oppositely tearing and pressing a metal sheet. Two of the terminals of the two rows of terminals respectively have two oppositely torn and cut portions seamlessly and oppositely connected together. The oppositely torn and cut portion of the one terminal is seamlessly connected to the oppositely torn and cut portions of the two neighboring terminals when one of the terminals of the one row of terminals is reversely and oppositely connected to the two neighboring terminals. The oppositely torn and cut portions of the at least one row of terminals are the extensions.

According to the above-mentioned structure, the extensions of two rows of terminals may be seamlessly oppositely connected together and then pressed, so that the material and the manufacturing cost may be reduced.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a pictorially exploded view showing a first embodiment of the invention.

FIG. 2 is a pictorially assembled view showing the first embodiment of the invention.

FIG. 3 is a cross-sectional side view showing the first embodiment of the invention.

FIGS. 4 and 5 are schematic illustrations showing manufacturing processes of pressing terminals of the first embodiment of the invention.

FIG. 6 is a schematic illustration showing cut surfaces of extensions of two rows of terminals according to the first embodiment of the invention.

FIG. 7 is a schematic illustration showing the cut surfaces of the extensions when one terminal of the first row of terminals is oppositely and reversely connected between two terminals according to the first embodiment of the invention.

FIG. 8 is a schematic illustration showing the cut surfaces of the extensions when one terminal of the first row of terminals is normally and reversely connected between two terminals according to the first embodiment of the invention.

FIG. 9 is a pictorially assembled view showing a second embodiment of the invention.

FIG. 10 is a pictorially assembled view showing a third embodiment of the invention.

FIG. 11 is a cross-sectional side view showing the third embodiment of the invention.

FIG. 12 is a schematic illustration showing manufacturing processes of pressing terminals according to the third embodiment of the invention.

FIG. 13 is a schematic illustration showing manufacturing processes of pressing terminals according to a fourth embodiment of the invention.

FIG. 14 is a pictorially exploded view showing a fifth embodiment of the invention.

FIG. 15 is a schematic illustration showing manufacturing processes of pressing terminals according to the fifth embodiment of the invention.

FIG. 16 is a pictorially exploded view showing a sixth embodiment of the invention.

FIG. 17 is a pictorial view showing a terminal according to the sixth embodiment of the invention.

FIG. 18 is a cross-sectional side view showing the sixth embodiment of the invention.

FIG. 19 is a schematic illustration showing manufacturing processes of pressing the terminals according to the sixth embodiment of the invention.

FIG. 20 is a pictorially exploded view showing a seventh embodiment of the invention.

FIG. 21 is a cross-sectional side view showing the seventh embodiment of the invention.

FIGS. 22 and 23 are pictorial views showing manufacturing processes of pressing terminals according to the seventh embodiment of the invention.

### DETAILED DESCRIPTION OF THE INVENTION

The present invention will be apparent from the following detailed description, which proceeds with reference to the accompanying drawings, wherein the same references relate to the same elements.

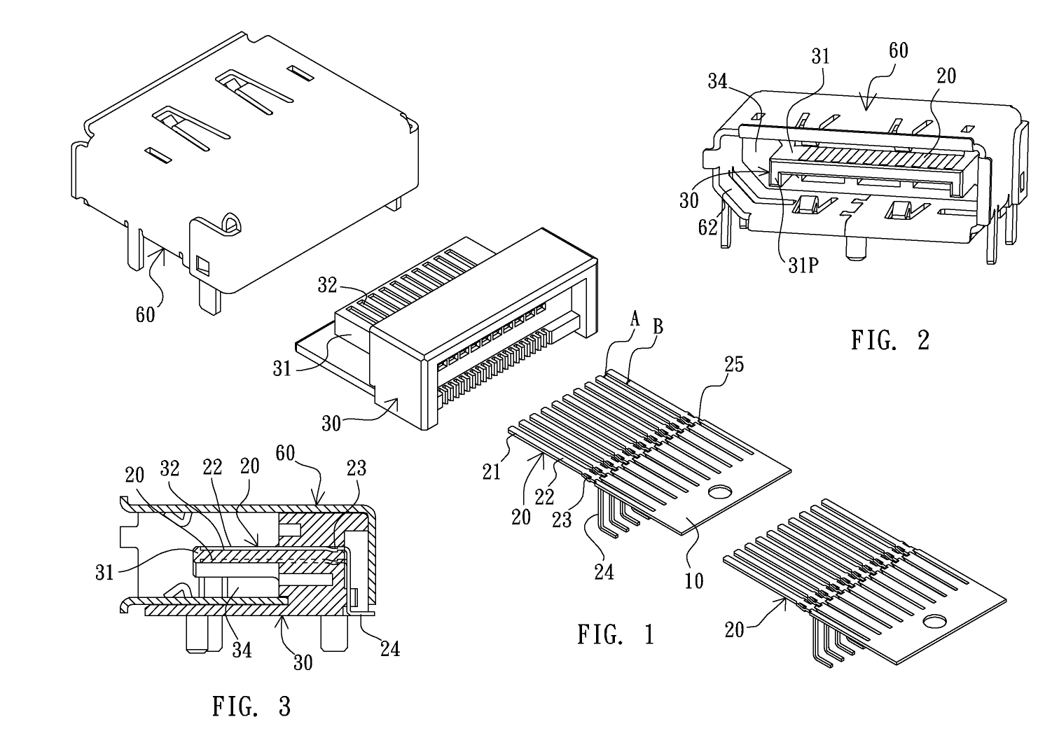

Referring to FIGS. 1 to 3, a display port connector of this embodiment includes a plastic base 30, two rows of terminals 20 and a metal housing 60.

The plastic base 30 has a tongue 31 and two rows of terminal slots 32. The tongue 31 extends and projects frontward and has two sides formed with projections 31P extending downward. The two rows of terminal slots 32 respectively extend to two surfaces of the tongue 31 and are staggered in the top-to-bottom direction.

The two rows of terminals 20 are disposed in the two rows of terminal slots 32 of the plastic base 30. There is one row of ten terminals separately connected to a material tape 10. The one row of terminals 20 is assembled into the one row of terminal slots 32, and then the material tape 10 is broken for separation. The terminal 20 has, from front to rear, an extension 22, a fixing portion 23 and a pin portion 24. The middle of the rear end of the fixing portion 23 is connected to the pin portion 24. Two sides of the rear end of the fixing portion 23 are connected to the material tape 10, and the connection portions therebetween are formed with cutting marks 25 for facilitating the breaking. The width of the fixing portion 23 is greater than the width of the extension 22 and the width of the pin portion 24. The fixing portion 23 is engaged with the terminal slot 32. The extension 22 is in surface contact with the terminal slot 32 and has a front end formed with a connection point 21. The pin portion 24 extends out of the bottom end of the plastic base 30. The extensions 22 of the two rows of terminals 20 are in surface contact with the tow surfaces of the tongue 31 and are staggered in the top-to-bottom direction.

The metal housing 60 covers the plastic base 30 and has a front section formed with a connection slot 34. The connection slot 34 has a bottom end and a top end, wherein the bottom end is narrower than the top end, and one side of the connection slot 34 is formed with an inclined edge 62. The tongue 31 is disposed in the connection slot 34.

Each of the two rows of terminals 20 is one of the two rows of terminals formed by oppositely tearing and pressing a metal sheet. Two terminals of the two rows of terminals respectively have two oppositely torn and cut portions seamlessly and oppositely connected together. When one terminal of the one row of terminals 20 is reversely and oppositely connected between two neighboring terminals, the oppositely torn and cut portion of the terminal 20 is seamlessly connected to the two oppositely torn and cut portions of the two neighboring terminals 20. The oppositely torn and cut portions of the two rows of terminals 20 are the extensions 22, and the gap A between the extensions 22 of the two neighboring terminals is equal to a width B of the extension 22.

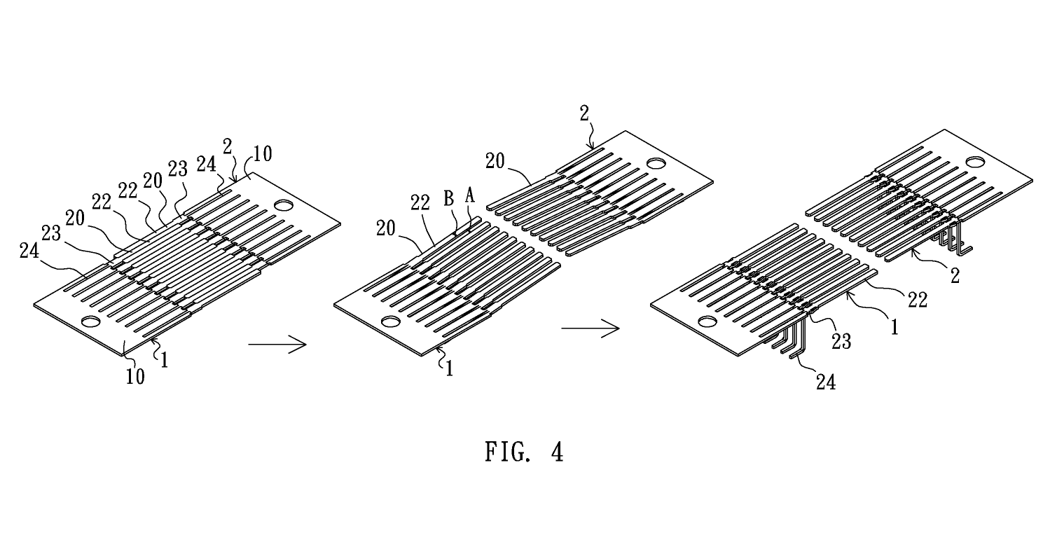

According to the above-mentioned structure, the terminals may be manufactured by way of pressing, as shown in FIG. 4. The two rows of separately and oppositely arranged and connected terminals may be formed by pressing a metal sheet. Because the gap A between the extensions 22 of the two neighboring terminals 20 is equal to the width B of the extension 22, the extension 22 of each terminal 20 of the first row of terminals 1 is seamlessly oppositely connected between the extensions 22 of the two neighboring terminals 20 of the second row of terminals 2. Thus, the metal sheet is firstly cut into the first and second rows of terminals 1 and 2, which are then separated, and then the pin portions 24 are formed by bending.

The manufacturing method of the electrical connector of the invention includes the following steps.

First, a plastic base 30 is provided. The plastic base 30 has a tongue 31 and two rows of terminal slots 32. The tongue 31 extends and projects frontward and has two sides formed with downward projections 31P. The two rows of terminal slots 32 respectively extend to two surfaces of the tongue 31 and are staggered in the top-to-bottom direction.

Next, two rows of terminals 20 are disposed in the two rows of terminal slots 32 of the plastic base 30. Each row of terminals 20 has ten separate terminals connected to a material tape 10. The one row of terminals 20 is assembled in the one row of terminal slots 32 and then separated from the material tape 10 by way of breaking. The terminal 20 has, form the front end to the rear end, an extension 22, a fixing portion 23 and a pin portion 24. The middle of the rear end of the fixing portion 23 is connected to the pin portion 24. Two sides of the rear end of the fixing portion 23 are connected to the material tape 10, and the connection portions therebetween are formed with cutting marks 25 for facilitating the breaking. The width of the fixing portion 23 is greater than the width of the extension 22 and the width of the pin portion 24. The fixing portion 23 is engaged with the terminal slot 32. The extension 22 is in surface contact with the terminal slot 32 and has a front end formed with a connection point 21. The pin portion 24 extends out of the bottom end of the plastic base 30. The extensions 22 of the two rows of terminals 20 are in surface contact with the two surfaces of the tongue 31 and are staggered in the top-to-bottom direction.

Each of the two rows of terminals 20 is one of the two rows of terminals formed by oppositely tearing and pressing a metal sheet. Two terminals of the two rows of terminals respectively have two oppositely torn and cut portions seamlessly and oppositely connected together. When one terminal of the one row of terminals 20 is reversely and oppositely connected between two neighboring terminals, the oppositely torn and cut portion of the terminal 20 is seamlessly connected to the two oppositely torn and cut portions of the two neighboring terminals 20. The oppositely torn and cut portions of the two rows of terminals 20 are the extensions 22, and the gap A between the extensions 22 of the two neighboring terminals is equal to a width B of the extension 22.

Then, a metal housing 60 is provided. The metal housing 60 covers the plastic base 30 and has a front section formed with a connection slot 34. The connection slot 34 has a bottom end and a top end, wherein the bottom end is narrower than the top end, and one side of the connection slot 34 is formed with an inclined edge 62. The tongue 31 is disposed in the connection slot 34.

In the manufacturing of the terminals, when the two rows of terminals oppositely connected together are formed by way of pressing, the extensions of the two rows of terminals are seamlessly connected together, and the ratio of the length of the extension 22 to the length of the overall terminal is relatively large. The material can be significantly saved, and the manufacturing cost can be reduced.

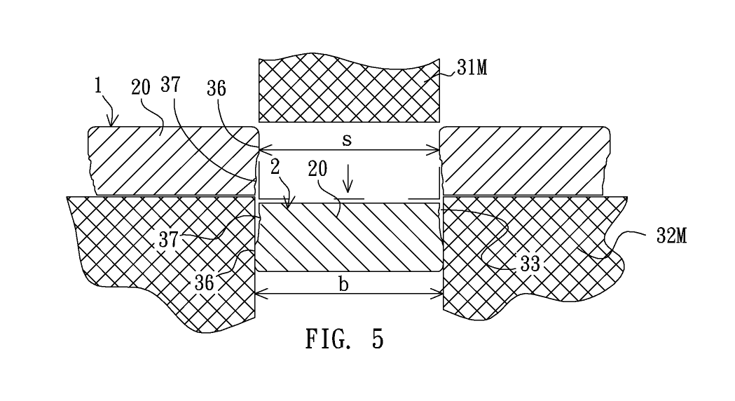

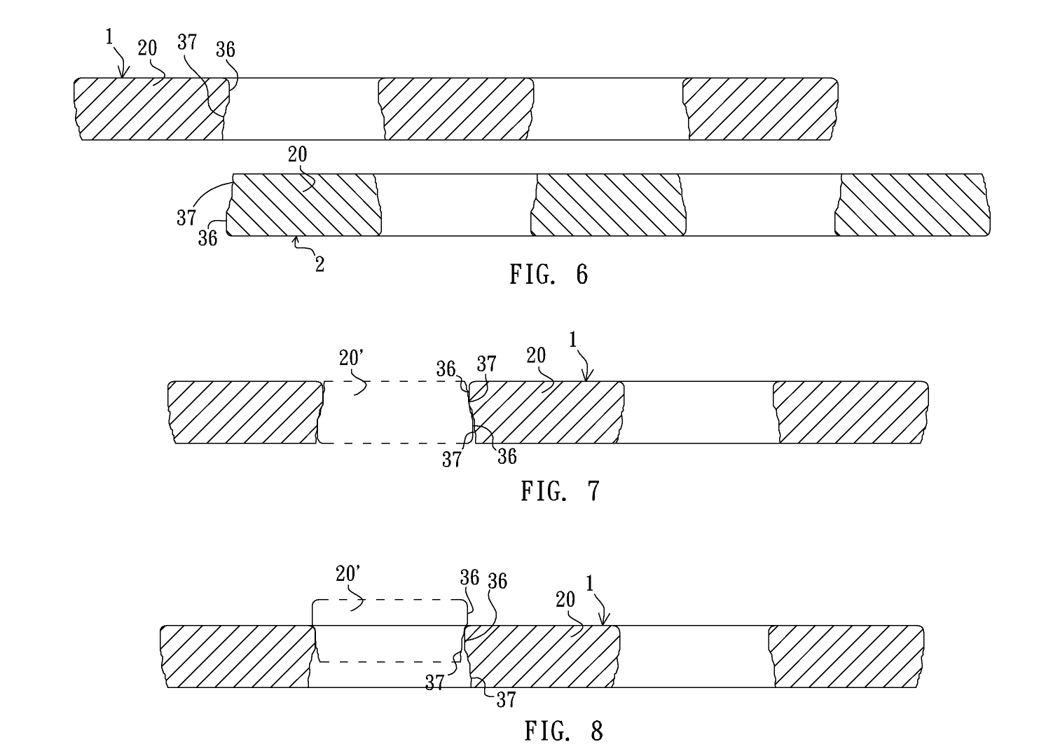

As shown in FIGS. 5 and 6, when the metal sheet of the invention is oppositely torn and pressed, the width s of the upper mold 31M of the mold is inevitably smaller than the width b of the punched hole 33 of the lower mold 32M. The extension of the terminal 20 of the first row of terminals 1 and the extension of the terminal 20 of the second row of terminals 2 are seamlessly oppositely torn. So, the cut surface of the extension of the terminal 20 of the first row of terminals 1 after pressing has an upper section formed with a smooth surface 36, and a lower section formed with a burr 37. However, the cut surface of the extension of the terminal 20 of the second row of terminals 2 has a lower section formed with a smooth surface 36, and an upper section formed with a burr 37. When the terminal 20 of the first row of terminals 1 and the terminal 20 of the second row of terminals 2 are combined together, the burr 37 of the cut surface of the extension is combined with the smooth surface 36 of the cut surface of the extension so that the sealed connection can be formed.

Thus, the upper width of the extension of the terminal 20 of the first row of terminals 1 after pressing and the lower width of the extension of the terminal 20 of the second row of terminals 2 are equal to b, while the lower width of the extension of the terminal 20 of the first row of terminals 1 and the upper width of the extension of the terminal 20 of the second row of terminals 2 are equal to s, wherein b is slightly greater than s. That is, when the terminal 20 of the first row of terminals 1 is placed upside down, the cut surface of the extension thereof is the same as the cut surface of the extension of the terminal 20 of the second row of terminals 2.

As shown in FIG. 7, when one terminal 20′ of the first row of terminals 1 is oppositely and reversely connected between two terminals, the burr 37 of the cut surface of its extension is connected to the smooth surfaces 36 of the cut surfaces of the two neighboring terminals 20, so that the sealed connection can be formed.

As shown in FIG. 8, when one terminal 20′ of the first row of terminals 1 is normally and reversely connected between two terminals, the smooth surface 36 of the cut surface of the extension thereof is connected between the smooth surfaces 36 of the cut surfaces of the extensions of the two neighboring terminals 20 so that the sealed connection cannot be formed.

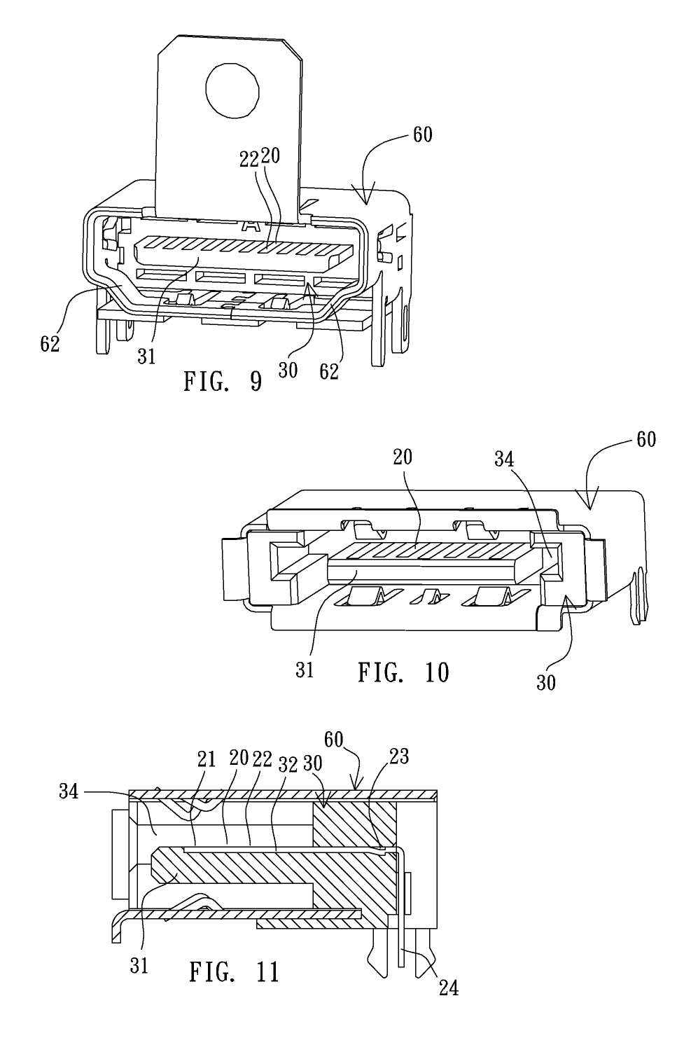

As shown in FIG. 9, the second embodiment of the invention is a high definition multimedia interface (HDMI) connector, which is almost the same as the first embodiment except that the connection slot 34 of this embodiment has the bottom end narrower than the top end, and has two sides formed with two inclined edges 62, and that two sides of the tongue 31 are not formed with downward projections. The two rows of terminals 20 include one row of ten terminals and one row of nine terminals. The two rows of terminals 20 have extensions 22 in surface contact with two surfaces of the tongue 31 and are staggered in the top-to-bottom direction.

As shown in FIGS. 10 to 12, the third embodiment of the invention is an external serial ATA (eSATA) connector, which includes a plastic base 30, one row of terminals 20 and a metal housing 60.

The plastic base 30 has a tongue 31 and one row of terminal slots 32. The tongue 31 extends and projects frontward, and the one row of terminal slots 32 extends to the top of the tongue 31.

The one row of terminals 20 is disposed in the two rows of terminal slots 32 of the plastic base 30. Each row of seven terminals 20 is connected to a material tape 10. After the one row of terminals 20 is assembled into the one row of terminal slots 32, the material tape 10 is broken for separation. The terminal 20 has, form the front end to the rear end, an extension 22, a fixing portion 23 and a pin portion 24. The rear end of the fixing portion 23 is connected to the material tape 10 and the connection portion is formed with a cutting mark to facilitate the breaking. The width of the fixing portion 23 is greater than the width of the extension 22 and the width of the pin portion 24. The fixing portion 23 is engaged with the terminal slot 32. The extension 22 is in surface contact with the terminal slot 32 and has a front end formed with a connection point 21. The pin portion 24 extends out of the bottom end of the plastic base 30. The lengths of the extensions 22 of the terminals 20 are different, wherein three long extensions and four short extensions are formed.

The metal housing 60 covers the plastic base 30. The front section of the metal housing 60 and the plastic base 30 form a connection slot 34, in which the tongue 31 is disposed.

The one row of terminals 20 is one row of terminals of two rows of terminals formed by oppositely tearing and pressing a metal sheet. Two terminals of the two rows of terminals respectively have two oppositely torn and cut portions seamlessly and oppositely connected together. When one terminal 20 of the one row of terminals 20 is reversely and oppositely connected between two neighboring terminals, the oppositely torn and cut portion of the terminal 20 is seamlessly connected to the two oppositely torn and cut portions of the two neighboring terminals 20. The oppositely torn and cut portions of the two rows of terminals 20 are the extensions 22, and the gap A between the extensions 22 of the two neighboring terminals is equal to a width B of the extension 22.

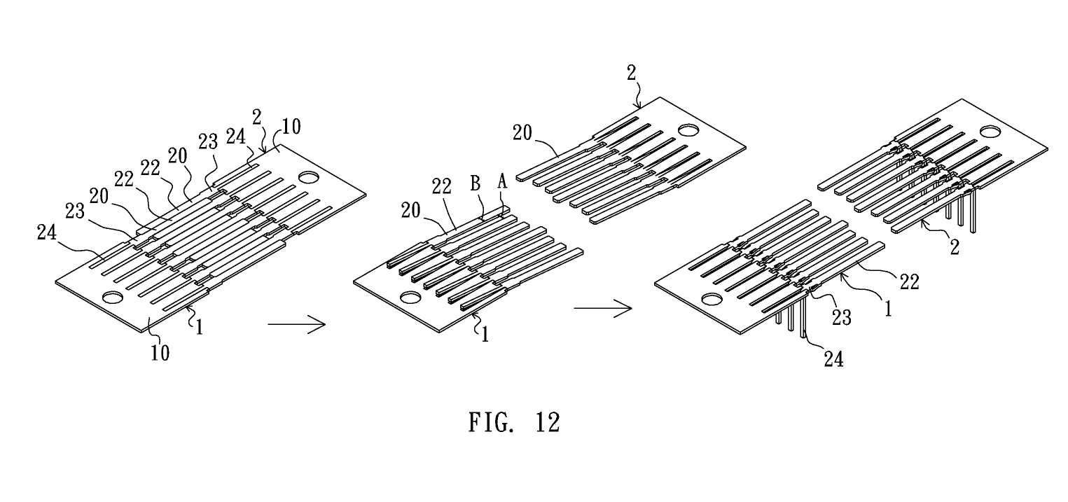

According to the above-mentioned structure, the terminals may be manufactured, as shown in FIG. 12, wherein two rows of terminals may be oppositely connected together and may be formed by pressing a metal sheet. Because the gap A between the extensions 22 of the two neighboring terminals 20 is equal to the width B of the extension 22, the extension 22 of each terminal 20 of the first row of terminals 1 is seamlessly oppositely connected between the extensions 22 of the two neighboring terminals 20 of the second row of terminals 2. Thus, the metal sheet is firstly oppositely cut into the first and second rows of terminals 1 and 2, which are then separated, and then the pin portions 24 are formed by way of bending.

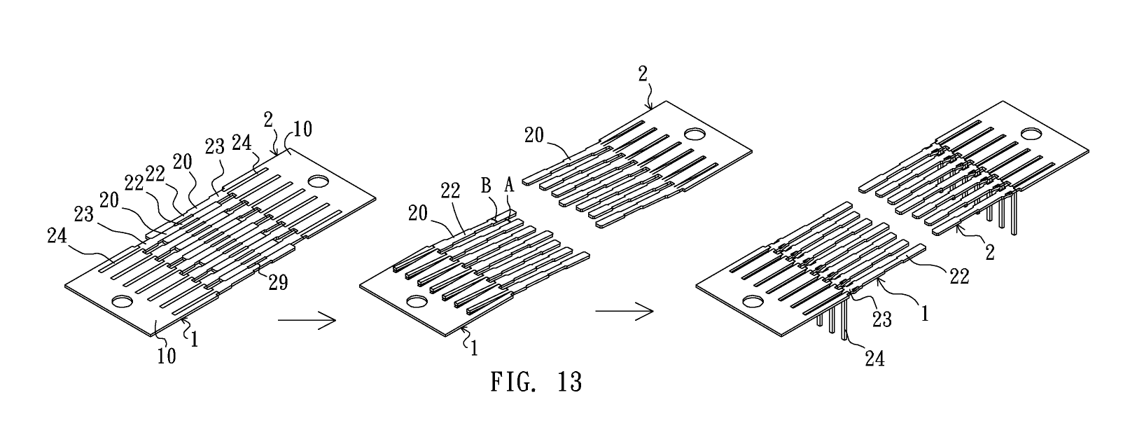

As shown in FIG. 13, the fourth embodiment of the invention is almost the same as the third embodiment except that the extension 22 of this embodiment is not entirely the oppositely torn and cut portion, but is partially the oppositely torn and cut portion, and partially the non-oppositely torn and cut portion. So, when the extension 22 of each terminal 20 of the first row of terminals 1 is oppositely connected between the extensions 22 of the two neighboring terminals 20 of the second row of terminals 2, the partially seamless connection is formed to form the gaps 29.

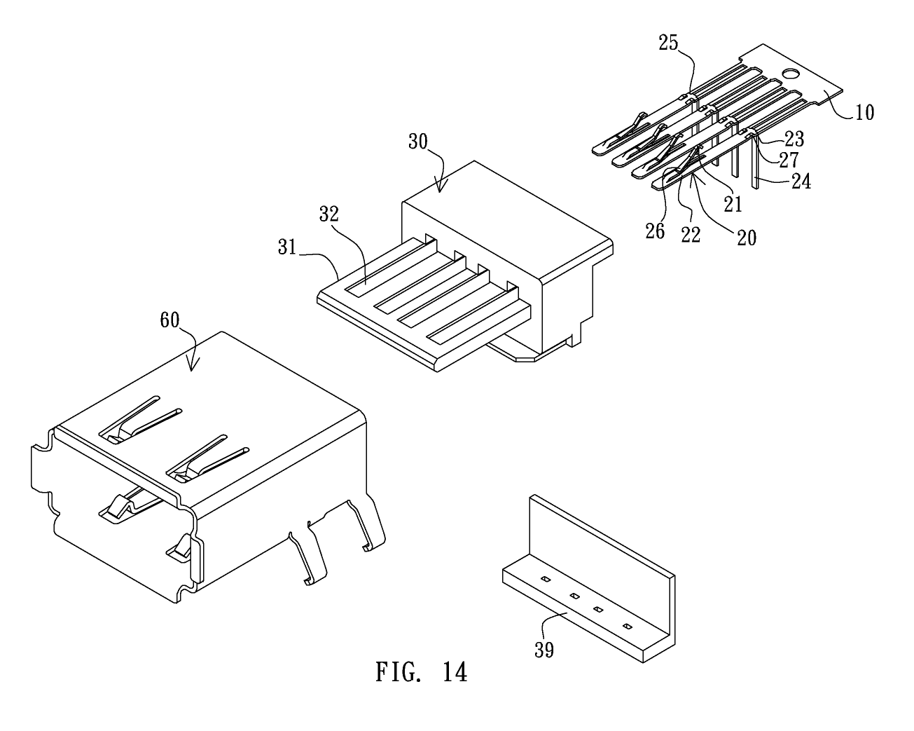

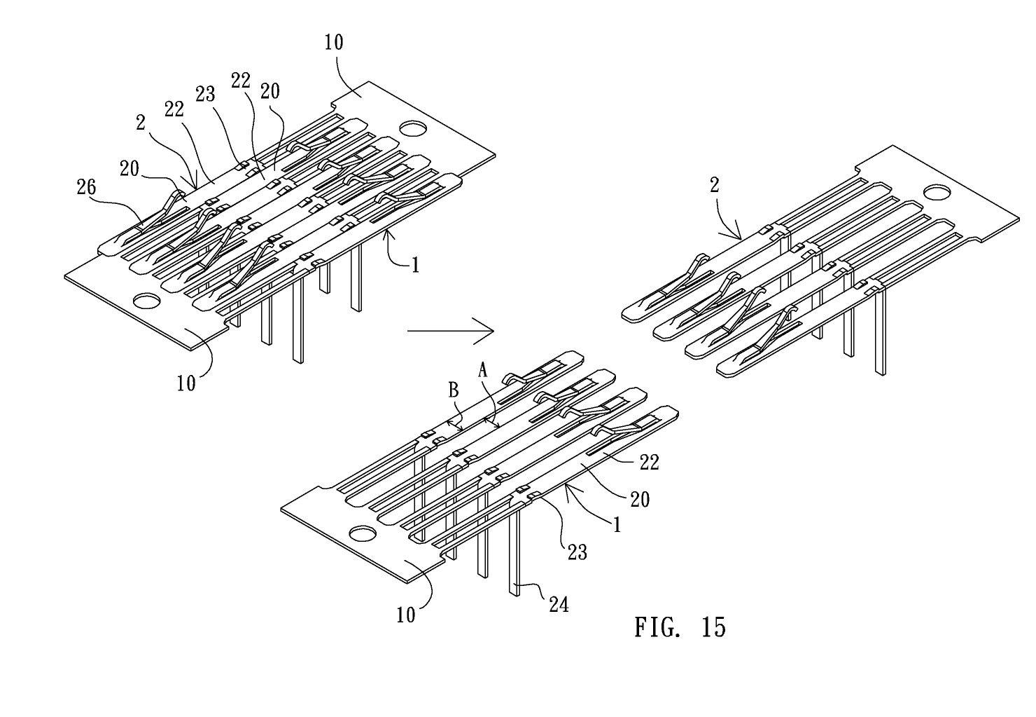

As shown in FIGS. 14 and 15, the fifth embodiment of the invention is a universal serial bus (USB) connector, which includes a plastic base 30, one row of terminals 20 and a metal housing 60.

The plastic base 30 has a tongue 31 and one row of terminal slots 32. The tongue 31 extends and projects frontward. The one row of terminal slots 32 respectively extends to the top of the tongue 31. In addition, a rear cover 39 is further provided to cover, from bottom to top, the rear end of the plastic base 30.

The one row of terminals 20 is disposed in the one row of terminal slots 32 of the plastic base 30. Each row of four terminals 20 is connected to a material tape 10. The one row of terminals 20 is assembled in the one row of terminal slots 32 and then separated from the material tape 10 by way of breaking. The terminal 20 has, form the front end to the rear end, an extension 22, a fixing portion 23 and a pin portion 24. The rear end of the fixing portion 23 is connected to the material tape 10, and the connection portion therebetween is formed with a cutting mark 25 for facilitating the breaking. The fixing portion 23 has a barb 27 to be engaged with the terminal slot 32. The extension 22 is in surface contact with the terminal slot 32, and an elastic sheet 26 is prodded and pressed near the plate surface of the front end. One end of the elastic sheet 26 is connected to the extension 22, and the other end of the elastic sheet 26 extends backward and is opened. The elastic sheet has a projecting connection point 21, and the pin portion 24 extends out of the bottom end of the plastic base 30.

The metal housing 60 covers the plastic base 30. The front section of the metal housing 60 is formed with a connection slot 34, in which the tongue 31 is disposed.

The one row of terminals 20 is one of the two rows of terminals formed by oppositely tearing and pressing a metal sheet. Two terminals of the two rows of terminals respectively have two oppositely torn and cut portions seamlessly and oppositely connected together. One terminal of the one row of terminals 20 is reversely and oppositely connected between two neighboring terminals, and the oppositely torn and cut portion of the one terminal 20 is seamlessly connected to the oppositely torn and cut portions of the two neighboring terminals 20. The oppositely torn and cut portions of the one row of terminals 20 are the extensions 22 and the fixing portions 23, and the extension 22 and the fixing portion 23 have the equal width. The gaps A between the extensions 22 and the fixing portions 23 of the two neighboring terminals are equal to the widths B of the extension 22 and the fixing portion 23.

According to the above-mentioned structure, the terminals may be formed by way of pressing, as shown in FIG. 15. Two rows of separately arranged and connected terminals may be formed by oppositely pressing a metal sheet. Because the gaps A of the extensions 22 and the fixing portions 23 of the two neighboring terminals 20 are equal to the widths B of the extension 22 and the fixing portion 23, the extension 22 and the fixing portion 23 of each terminal 20 of the first row of terminals 1 are seamlessly oppositely connected between the extensions 22 and the fixing portions 23 of the two neighboring terminals 20 of the second row of terminals 2. Thus, the metal sheet is oppositely cut into the first and second rows of terminals 1 and 2, which are then separated, and then the pin portion 24 is formed by way of bending.

In this embodiment, the oppositely torn and cut portions are the extension 22 and the fixing portion 23, so the oppositely torn and pressed portion of the terminal is very long, and the used material of the terminals is significantly saved.

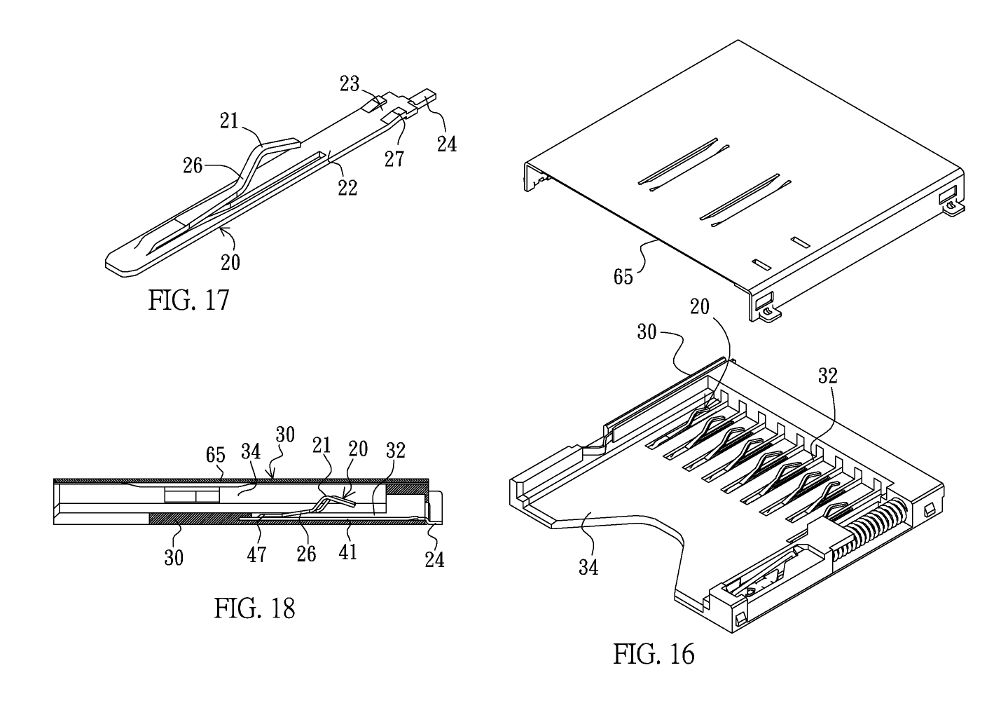

As shown in FIGS. 16 to 19, the sixth embodiment of the invention is a memory card connector including a plastic base 30, one row of terminals 20 and a metal upper cover 65.

The plastic base 30 has one row of separately arranged terminal slots 32 and a connection slot 34. The connection slot 34 can accommodate a memory card.

The one row of terminals 20 is disposed in the one row of terminal slots 32 of the plastic base 30. Each row of nine separately arranged terminals 20 is connected to a material tape 10. The one row of terminals 20 is assembled in one row of terminal slots 32, and then the material tape 10 is broken for separation. The terminal 20 has, form the front end to the rear end, an extension 22, a fixing portion 23 and a pin portion 24. The rear end of the fixing portion 23 is connected to the material tape 10, and the connection portion therebetween is formed with a cutting mark for facilitating the breaking. The fixing portion 23 has a barb 27 to be engaged with the terminal slot 32. The extension 22 is in surface contact with the terminal slot 32 and has a front end engaged with the terminal slot 32. An elastic sheet 26 is formed near the plate surface of the front end of the extension 22 by way of prodding and pressing. The elastic sheet 26 has one end connected to the extension 22, and the other end extending backward and being opened. The elastic sheet has a projecting connection point 21, and the pin portion 24 extends out of the bottom end of the plastic base 30.

The metal upper cover 65 has a top surface and two side surfaces, and covers the plastic base 30.

The one row of terminals 20 is one row of two rows of terminals formed by oppositely tearing and pressing a metal sheet. Two terminals of the two rows of terminals respectively have two oppositely torn and cut portions seamlessly and oppositely connected together. When one terminal 20 of the one row of terminals 20 is reversely and oppositely connected between two neighboring terminals, the oppositely torn and cut portion of the one terminal 20 is seamlessly connected to the oppositely torn and cut portions of the two neighboring terminals 20. The oppositely torn and cut portions of the one row of terminals 20 are the extensions 22 and the fixing portions 23, and the extension 22 and the fixing portion 23 have the equal width. The gaps A between the extensions 22 and the fixing portions 23 of the two neighboring terminals are equal to the widths B of the extension 22 and the fixing portion 23.

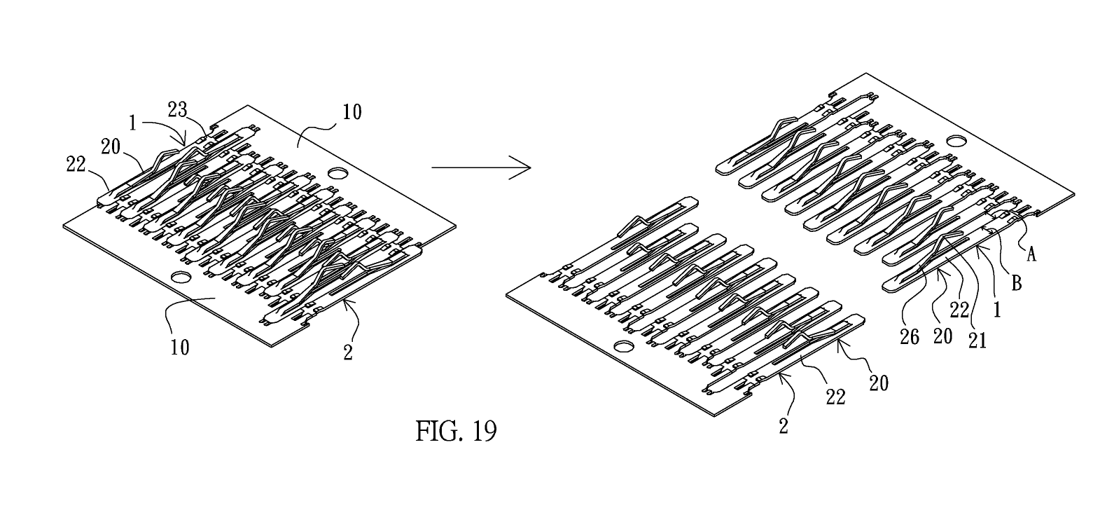

According to the above-mentioned structure, the terminals may be manufactured by way of pressing, as shown in FIG. 19. The two rows of separately arranged and connected terminals may be formed by oppositely pressing a metal sheet. The gaps A between the extensions 22 and the fixing portions 23 of the two neighboring terminals 20 are equal to the widths B of the extensions 22 and the fixing portions 23. So, the extension 22 and the fixing portion 23 of each terminal 20 of the first row of terminals 1 are seamlessly oppositely connected between the extensions 22 and the fixing portions 23 of the two neighboring terminals 20 of the second row of terminals 2. Thus, the metal sheet is firstly oppositely cut into the first and second rows of terminals 1 and 2, the front end of the extension 22 of each terminal of the first row of terminals 1 is firstly connected to the material tape 10 of the second row of terminals 2, and the front end of the extension 22 of each terminal of the second row of terminals 2 is firstly connected to the material tape 10 of the first row of terminals 1. Thus, the first row of terminals 1 and the second row of terminals 2 may be simultaneously plated, then cut, and then separated, so that the plating process may be simplified, and the two rows of terminals may be connected together more firmly.

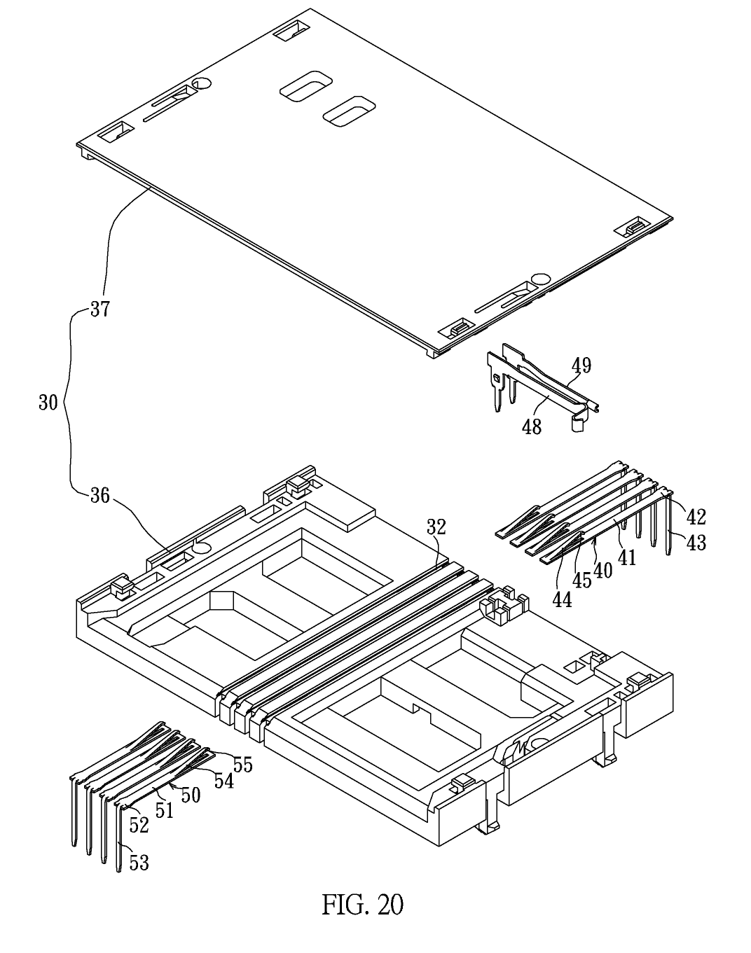

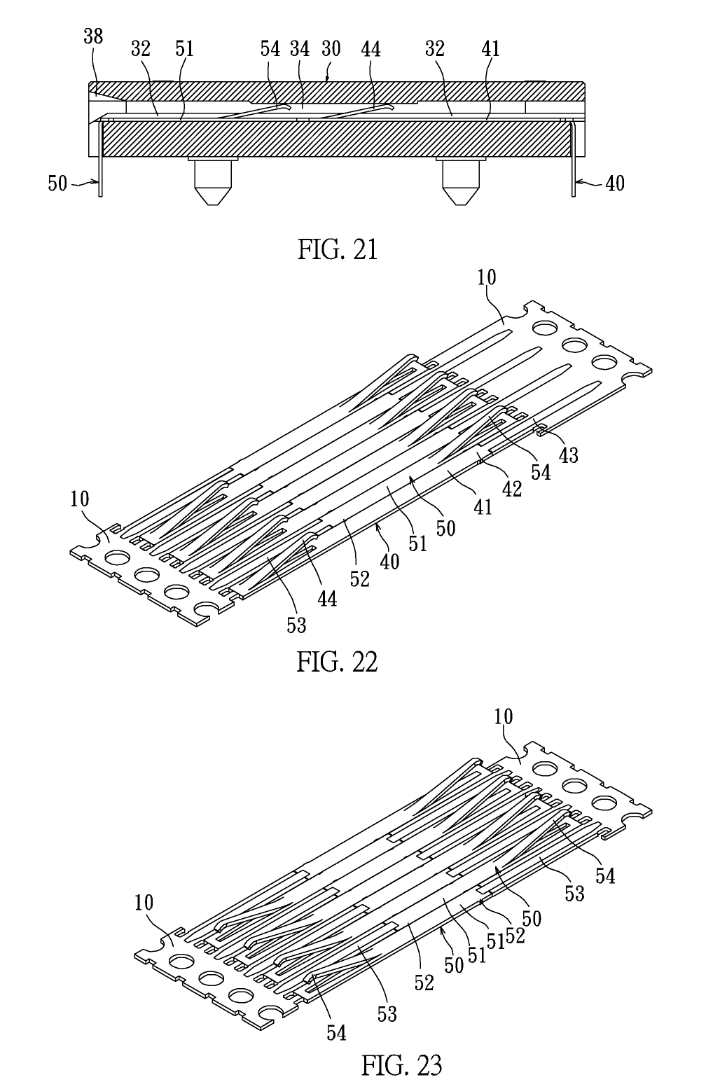

As shown in FIGS. 20 and 21, the seventh embodiment of the invention is a smart card connector, which includes a plastic base 30, one row of first terminals 40 and one row of second terminals 50.

The plastic base 30 has a base 36, an upper cover 37 covering the base 36, and a connection slot 34 for accommodating a smart card. The front end of the plastic base is formed with an insert port 38 of the connection slot. One pair of switch terminals 48 and 49 is disposed near the rear end of the base 36. When the smart card is inserted into the connection slot 34, the one pair of the switch terminals 48 and 49 may be triggered. The middle section of the base 36 is formed with one row of terminal slots 32, which is separately arranged and penetrates through the base 36 in a front-to-rear direction.

The one row of first terminals 40 is disposed on the rear sections of the one row of terminal slots 32. Each first terminal 40 has, from front to rear, an extension 41, a fixing portion 42 and a pin portion 43. The extension 41 extends horizontally and is in surface contact with the bottom surface of the terminal slot 32. The plate surface of the front section thereof is upwardly prodded and pressed to form a projecting elastic sheet 44. The elastic sheet has a projecting connection point 45, one end connected to the front end of the extension, and the other end projectingly extending in the direction toward the pin portion 43 and being opened. The elastic sheet 44 projects beyond the terminal slot 32 to the connection slot 34. The fixing portion 42 is fixed in the terminal slot 32. The pin portion 43 extends to the rear end of the plastic base 30 and extends out of the plastic base 30.

The one row of second terminals 50 is disposed in the front sections of the one row of terminal slots 32 and aligned with the one row of first terminals 40 in a front-to-rear direction. Each second terminal 50 has, from one end to the other end, an extension 51, a fixing portion 52 and a pin portion 53. The extension 51 extends horizontally, is shorter than the extension 41 of the first terminal 40, and is in surface contact with the bottom surface of the terminal slot 32. The plate surface of the front section of the extension 51 is downwardly prodded and pressed to form a projecting elastic sheet 54. The elastic sheet 54 is an elastic sheet having one end connected to the extension, and the other end projectingly extending in a direction away from the pin portion 53 and being opened. The elastic sheet 54 projects beyond the terminal slot 32 to the connection slot 34. The fixing portion 52 is fixed in the terminal slot 32, and the pin portion 53 extends to the front of the plastic base 30 and extends out of the plastic base 30.

As shown in FIG. 22, the one row of first terminals 40 and the one row of second terminals 50 are formed by oppositely tearing and pressing a copper sheet. Each terminal has an oppositely torn and cut portion. The one row of first terminals 40 and the one row of second terminals 50 are reversely and oppositely connected together. The oppositely torn and cut portion of each terminal of the one row of first terminals 40 is seamlessly connected between the oppositely torn and cut portions of the two neighboring terminals of the second row of terminals 50. The oppositely torn and cut portions of the first and second terminals 40 and 50 are the extensions. The width of the extension 41 of each of the one row of first terminals 40 is the same as the gap between the extensions 41 of the two neighboring terminals. The width of the extension 51 of each of the one row of second terminals 50 is the same as the gap between the extensions 51 of the two neighboring terminals. The extension 51 of each terminal 50 of the one row of second terminals is reversely and seamlessly connected between the extensions 41 of the two neighboring terminals of the first row of terminals 40. The front end of the extension 41 of each first terminal 40 of the one row of first terminals is connected to the material tape 10 of the one row of second terminals 50. The front end of the extension 51 of each second terminal 50 of the one row of second terminals is connected to the material tape 10 of the one row of first terminals 40. Thus, the one row of first terminals 40 and the one row of second terminals 50 may be simultaneously plated, then cut and then separated, so that the plating process may become more simplified and the two rows of terminals may be connected together more firmly.

Because the terminal gap of the smart card connector is equal to 2.54 mm, the width of the extension of each of the two rows of the first terminals and the second terminals is equal to 1.27 mm.

As shown in FIG. 23, two rows of second terminals 50 with the same shape are formed by oppositely tearing and pressing a copper sheet. In this example, the extensions 51 of two rows of second terminals 50 are reversely seamlessly connected together. In addition, two rows of first terminals 40 having the same shape may also be formed by oppositely tearing and pressing one copper sheet.

While the invention has been described by way of examples and in terms of preferred embodiments, it is to be understood that the invention is not limited thereto. To the contrary, it is intended to cover various modifications. Therefore, the scope of the appended claims should be accorded the broadest interpretation so as to encompass all such modifications.

What is claimed is:

1. An electrical connector, comprising:
a plastic base having at least one row of terminal slots; and
at least one row of terminals disposed in the at least one row of terminal slots of the plastic base, wherein each of the terminals has, from one end to the other end, an extension, a fixing portion and a pin portion, the fixing portion is fixed to the terminal slot, the extension is in surface contact with the terminal slot and has a connection point, and the pin portion extends out of the plastic base,
wherein the at least one row of terminals is one of two rows of terminals formed by oppositely tearing and pressing a metal sheet, two of the terminals of the two rows of terminals respectively have two oppositely torn and cut portions seamlessly and oppositely connected together, the oppositely torn and cut portion of the one terminal is seamlessly connected to the oppositely torn and cut portions of the two neighboring terminals when one of the terminals of the one row of terminals is reversely and oppositely connected to the two neighboring terminals, and the oppositely torn and cut portions of the at least one row of terminals are the extensions.

2. The electrical connector according to claim 1, wherein a gap between the extensions of the two neighboring terminals of the at least one row of terminals is equal to a width of the extension.

3. The electrical connector according to claim 1, wherein the extension is prodded and pressed to form an elastic sheet having the connection point.

4. The electrical connector according to claim 1, wherein the plastic base has a tongue, and the electrical connector further has a metal housing covering the plastic base, the metal housing is formed with a connection slot, and the at least one row of terminal slots extends to one surface of the tongue.

5. The electrical connector according to claim 4 being an eSATA connector, wherein the at least one row of terminals has one row of seven terminals, and the extensions of the one row of terminals have different lengths.

6. The electrical connector according to claim 4 being a display port connector, wherein two sides of the tongue are formed with downward projections, the at least one row of terminals comprises two rows of ten terminals, the two rows of terminals have extensions in surface contact with two surfaces of the tongue and are staggered in a top-to-bottom direction, and a bottom end of one side of the connection slot is narrower than a top end of the one side of the connection slot to form an inclined surface.

7. The electrical connector according to claim 4 being a HDMI connector, wherein bottom ends of two sides of the tongue are narrower than top ends of the two sides of the tongue so that two inclined surfaces are formed, the at least one row of terminals comprises one row of ten terminals and one row of nine terminals, the extensions of the two rows of terminals are in surface contact with two surfaces of the tongue and are staggered in a top-to-bottom direction, and bottom ends of two sides of the connection slot are narrower than top ends of the two sides of the connection slot so that two inclined surfaces are formed.

8. The electrical connector according to claim 4 being a USB connector, wherein the at least one row of terminals has one row of four terminals.

9. The electrical connector according to claim 1 being an electronic card connector having a connection slot to be connected to an inserted electrical card.

10. The electrical connector according to claim 9 being a smart card connector, wherein the electrical card is a smart card, the at least one row of terminals comprises two rows of terminals, the two rows of terminals are aligned in a front-to-rear direction, and a width of each of the extensions of the two rows of terminals is equal to 1.27 mm.

11. The electrical connector according to claim 1, wherein when the one row of terminals is developed and one of the terminals is reversely and oppositely connected between two neighboring terminals of the terminals, a cut surface of the extension of the terminal is seamlessly connected to cut surfaces of the extensions of the two neighboring terminals.

12. A terminal structure, comprising:
a material tape; and
one row of terminals separately arranged and connected to the material tape, wherein each of the terminals has, form one end to the other end, an extension, a fixing portion and a pin portion, a plate surface of the extension extends horizontally and has a connection point,
wherein the one row of terminals is one of two rows of terminals formed by oppositely tearing and pressing a metal sheet, two of the terminals of the two rows of terminals respectively have two oppositely torn and cut portions seamlessly and oppositely connected together, when one of the terminals of the one row of terminals is reversely and oppositely connected between two neighboring terminals of the one row of terminals, the oppositely torn and cut portion of the one terminal is seamlessly connected to the oppositely torn and cut portions of the two neighboring terminals, and the oppositely torn and cut portions of the one row of terminals are the extensions.

13. The structure according to claim 12, wherein a gap between the extensions of the two neighboring terminals of the one row of terminals is equal to a width of the extension.

14. The structure according to claim 12, wherein the extension is prodded and pressed to form an elastic sheet, and the elastic sheet has the connection point.

15. The structure according to claim 12, wherein a middle of a rear end of the fixing portion is connected to the pin portion, two sides of the rear end of the fixing portion are connected to the material tape, and connection portions between the two sides of the rear end of the fixing portion and the material tape are formed with cutting marks for facilitating breaking.

16. A terminal structure formed by oppositely tearing and pressing a metal sheet, the terminal structure comprising:
a first row of terminals comprising a material tape and terminals separately arranged and connected to the material tape, each of the terminals has, form one end to the other end, an extension, a fixing portion and a pin portion, a plate surface of the extension extends horizontally and is formed with a connection point, the extension of each of the terminals is an oppositely torn and cut portion; and
a second row of terminals having a material tape and terminals separately arranged and connected to the material tape, wherein each of the terminals has, form one end to the other end, an extension, a fixing portion and a pin portion, a plate surface of the extension extends horizontally and is formed with a connection point, and the extension of each of the terminals is an oppositely torn and cut portion, wherein
the first and second rows of terminals are reversely and oppositely connected together, and the oppositely torn and cut portion of each of the terminals of the first row of terminals is seamlessly connected between the oppositely torn and cut portions of two neighboring terminals of the second row of terminals.
